(19) United States
(12) Patent Application Publication
(10) Pub. No.: US 2025/0245510 A1
(43) Pub. Date: Jul. 31, 2025

(54) SYSTEM FOR POST-TRAINING QUANTIZATION OF LARGE LANGUAGE MODELS

(71) Applicant: AMAZON TECHNOLOGIES, INC., SEATTLE, WA (US)

(72) Inventors: TONG QIN, ANN ARBOR, MI (US); SANKALP DAYAL, SAN MATEO, CA (US); RAHUL BAKSHI, SAN JOSE, CA (US); LINGCHUAN MENG, SANTA CLARA, CA (US); VARADARAJAN GOPALAKRISHNAN, CUPERTINO, CA (US)

(21) Appl. No.: 18/422,646

(22) Filed: Jan. 25, 2024

(51) Int. Cl. G06N 3/0895

(52) U.S. Cl. CPC G06N 3/0895

(57) ABSTRACT

Post-training quantization of weight values and activation values substantially reduces the memory and processing requirements of floating-point (FP) large language models (LLMs). A quantization parameter training process is performed on the FP LLM to determine quantization parameters. Weight-activation scaling may be applied to linear modules of the LLM, including down projection layers, enabling subsequent per-tensor quantization for activation values. The weight and activations values of the FP LLM are quantized from FP to integer values. Different layers may have different integer sizes. For example, weight values may be reduced to 4 bit integers and activation values to 8 bit integers. Layers within the model are modified to operate on the integer values. For example, an integer SiLU module may provide an integer approximation of a sigmoid-weighted linear unit activation function.

### COMPUTER PROGRAM LISTING APPENDIX

This disclosure incorporates by reference the material submitted in the Computer Program Listing Appendix filed herewith.

### BACKGROUND

Large language models (LLMs) are used to process a wide variety of data in many different applications.

### BRIEF DESCRIPTION OF FIGURES

The detailed description is set forth with reference to the accompanying figures. In the figures, the left-most digit(s) of a reference number identifies the figure in which the reference number first appears. The use of the same reference numbers in different figures indicates similar or identical items or features. The figures are not necessarily drawn to scale, and in some figures, the proportions or other aspects may be exaggerated to facilitate comprehension of particular aspects.

FIG. 1 illustrates a system for performing post-training quantization of a previously trained Large Language Model (LLM) that utilizes floating point values, according to some implementations.

FIG. 2 illustrates a diagram of one block of an LLM, according to some implementations.

FIG. 3 illustrates a block diagram of a post-training quantization module, according to some implementations.

FIG. 4 is a flow diagram of a process to perform post-training quantization, according to some implementations.

FIG. 5 is a block diagram of a computing device to implement the system, according to some implementations.

While implementations are described herein by way of example, those skilled in the art will recognize that the implementations are not limited to the examples or figures described. It should be understood that the figures and detailed description thereto are not intended to limit implementations to the particular form disclosed but, on the contrary, the intention is to cover all modifications, equivalents, and alternatives falling within the spirit and scope as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to.

### DETAILED DESCRIPTION

Once trained, large language models (LLMs) are used to process a wide variety of data in many different applications to perform various tasks. The tasks may include natural language processing, language translation, image classification, and so forth. An LLM comprises many functional blocks, with those blocks comprising many layers. The LLM may utilize a transformer architecture. For example, an LLM may comprise the Large Language Model Meta AI (LLAMA) promulgated by Meta Platforms Inc. The process of training determines weight and other values that embody the trained task. During training, these values may be expressed as floating point (FP) numeric data. This allows each value to represent a large dynamic range. For example, the LLM may express weight values and activation values as 32 bit single-precision FP (FP32). The relatively large bit size of these FP values in the model as well as the functions associated with processing FP values requires a relatively large amount of storage space and processor time to process input during inference.

Various post-training quantization techniques have been developed in an attempt to develop reduced bit-depth versions of LLMs. However, existing techniques have provided limited improvements. For example, existing post-training quantization techniques may only quantize linear elements in the model, leaving non-linear elements unquantized. This provides some reduction in memory requirements, but processor requirements to handle the unquantized values in the non-linear portions remain. In another example, existing post-training quantization techniques may result in a quantized model that exhibits substantially degraded accuracy compared to the unquantized model.

Described in this disclosure are techniques and systems for post-training quantization of LLMs that enable creation of an integer LLM that has accuracy that is comparable to an unquantized FP LLM. During the quantization process, weight and other values in the FP LLM are converted to integer values. Non-linear elements of the FP LLM are replaced in the integer LLM with equivalents that approximate the operation of the non-linear elements. One of the elements of the FP LLM is a linear down projection layer after an activation layer. The linear down projection layer may be used to reduce the dimensionality of an input. For example, the down projection layer may process output from a sigmoid-weighted linear unit (SiLU) activation function. Weight-activation scaling may be applied to linear elements, including the down projection layer. This enables per-tensor quantization for activation values to be successfully performed, significantly reducing or eliminating the degradation in accuracy that is traditionally associated with quantization.

This quantization to integer values with smaller bit-depths using the techniques and systems described results in an integer LLM that uses substantially less computer memory during storage and operation and allows more rapid execution using integer processing elements of a processor. As a result, the integer LLM is able to be used on devices with constrained resources such as limited memory and lower power processors. This brings the functionality of the LLM to edge devices, resulting in improved user experience and a reduction or elimination of use of network bandwidth to send data to a server executing the LLM. User privacy may also be improved as data may be processed locally by the integer LLM, instead of being sent to another device.

### Illustrative System

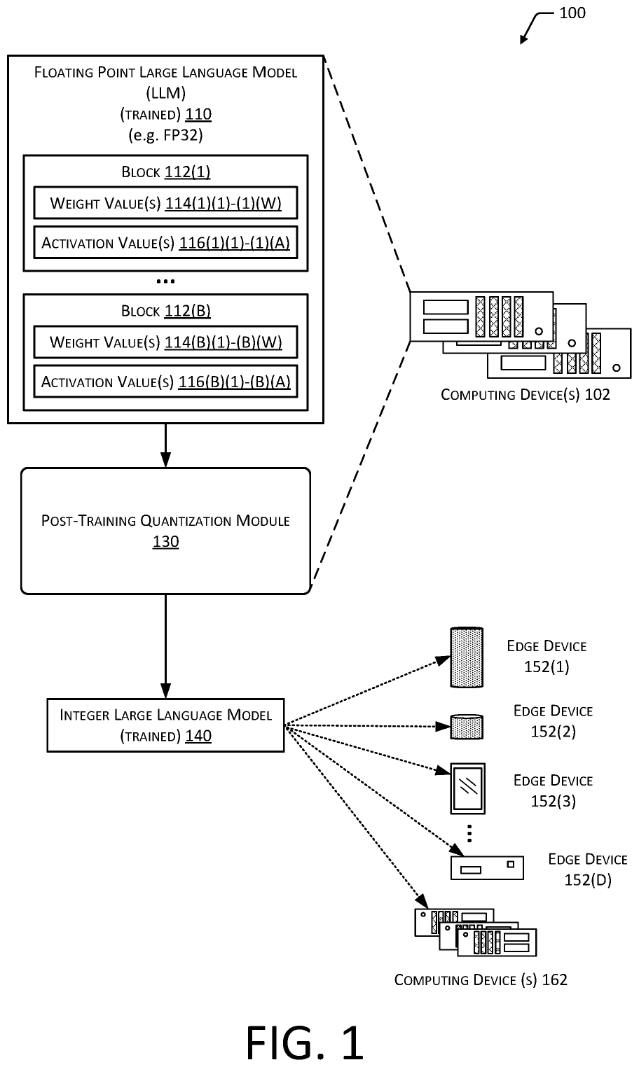

FIG. 1 illustrates a system 100 for performing post-training quantization of a previously trained LLM that utilizes floating point values, according to some implementations.

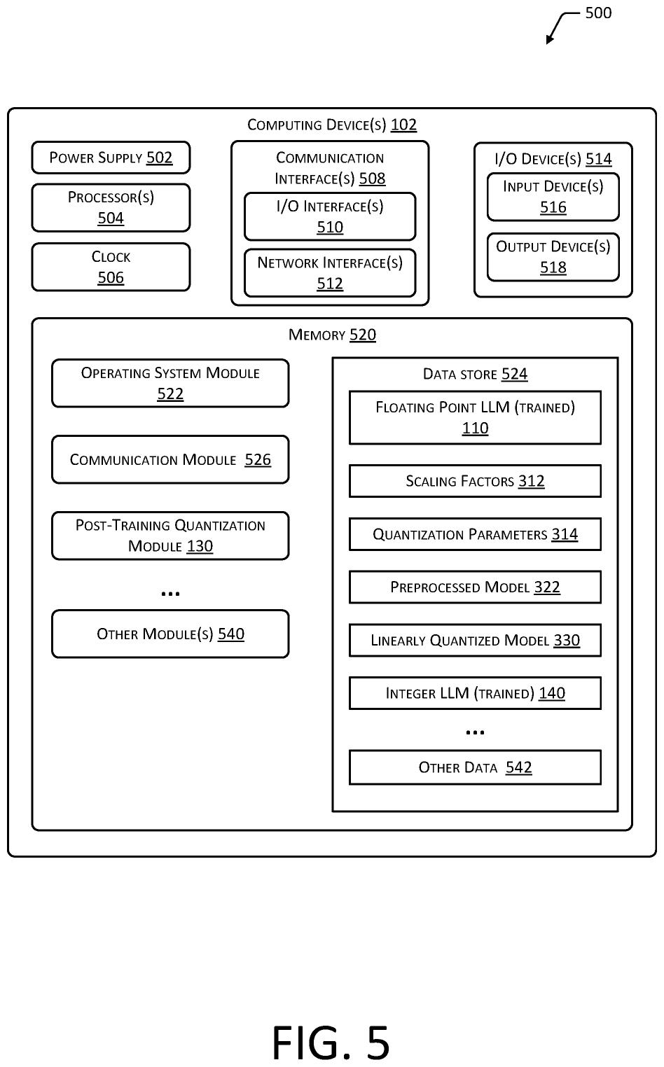

One or more computing devices 102 may be used to train and store a floating point (FP) LLM 110. For example, the computing devices 102 may comprise a discrete server, a set of cloud compute resources, and so forth. The computing device 102 is discussed in more detail with regard to FIG. 5.

The FP LLM 110 may utilize a transformer architecture. For example, the FP LLM 110 may comprise the Large Language Model Meta AI (LLAMA) promulgated by Meta Platforms Inc. In some implementations, the LLAMA 7B model architecture may be used. In other implementations other architectures may be used.

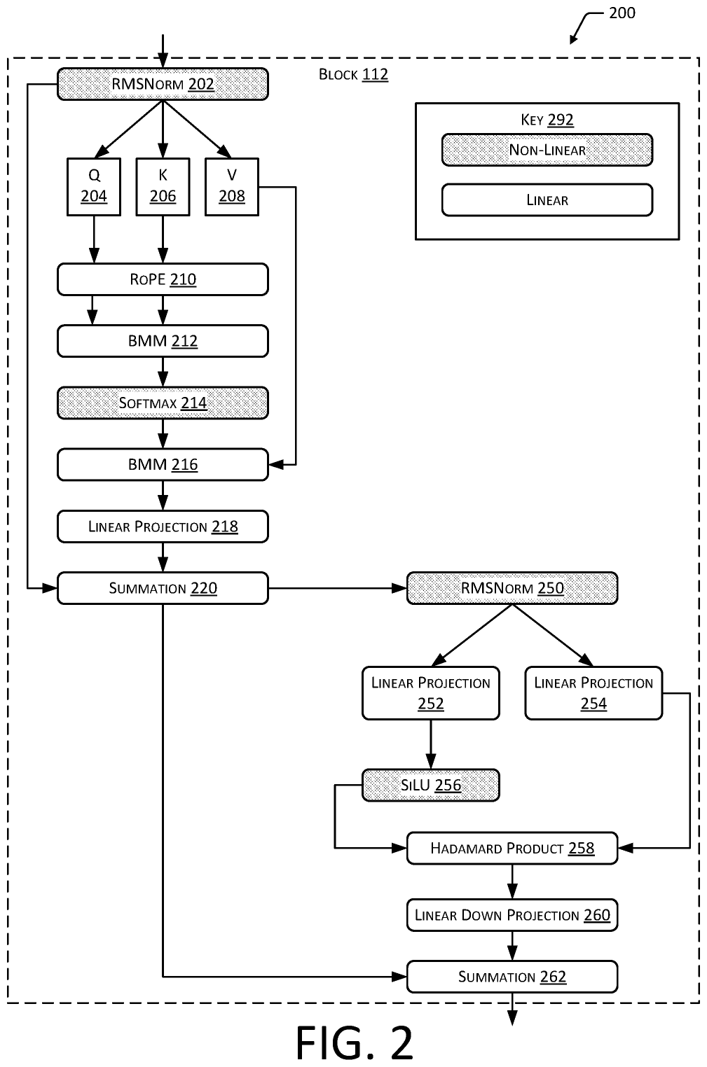

The FP LLM 110 comprises a plurality of blocks 112(1), 112(2), . . . , 112(B). Each block 112 may comprise a plurality of layers, each layer comprising one or more elements that process data. Some elements may be linear elements, in which they perform linear mathematical operations. Some elements may be non-linear elements, in which they perform non-linear mathematical operations. Different blocks 112 may be comprised of different layers. An example of one portion of a block 112 is described with regard to FIG. 2.

During training, weight values 114 and activation values 116 are determined for the model blocks 112(1)-(B) that comprise the FP LLM 110. The weight values 114 may be indicative of a weight value to be associated with an input or output of a node within the block. Once trained, the weight values 114 may be fixed. The activation values 116 may be based at least in part on a current input to the FP LLM 110. As a result, the activation values 116 may vary after training. For example, the activation values 116 may be determined by processing an input with a non-linear function. In this illustration, block 112(1) is associated with weight values 114(1)(1), 114(1)(2), . . . , 114(1)(W) and activation values 116(1)(1), 116(1)(2), . . . , 116(1)(A). Similarly, block 112(B) is associated with weight values 114(B)(1), 114(B)(2), . . . , 114(B)(W) and activation values 116(B)(1), 116(B)(2), . . . , 116(B)(A). In some implementations other values may be determined during training. For example, bias values may be determined during training.

Within the FP LLM 110 during and after training, values are expressed as FP numeric data. This allows each value to represent a large dynamic range. For example, the FP LLM 110 may express weight values 114 and activation values 116 as 32 bit single-precision FP (FP32). The elements of the FP LLM 110 also comprise functions that operate on these FP values. For example, layers implementing a SoftMAX function, a sigmoid-weighted linear unit (SiLU) activation function, and so forth utilize functions that operate on FP data.

The relatively large bit size of these FP weight values 114, bias values, or other model parameters in the FP LLM 110 requires a relatively large amount of storage space. For example, the FP LLM 110 may require 28 gigabytes (GB) of storage. While a large computing device 102 such as a server may have sufficient memory to store the FP LLM 110 this may be infeasible for other devices with constrained resources, such as edge devices 152. For example, edge devices 152 may comprise network enabled speakers 152(1), security devices 152(2), smartphones 153(3), or other edge devices 152(D) such as in-home edge servers, televisions, and so forth. One consequence of this has been executing the FP LLM 110 on the computing devices 102, receiving input from the edge devices 152, and then returning the results to the edge devices 152. However, this requires that the computing devices 102 scale to accommodate the incoming requests, consumes network bandwidth, and may introduce latency due to delays in transmitting data over the network. Furthermore, this results in the FP LLM 110 being unavailable to the edge device 152 if no network connection is available to communicate with the computing device 102.

A post-training quantization module 130 may be executed by the computing devices 102. The post-training quantization module 130 accepts the FP LLM 110 as input and provides as output an integer LLM 140. The post-training quantization module 130 determines scaling factors and quantization parameters that are subsequently used for model preprocessing and quantization, respectively. Weights and activations associated with linear elements of the FP LLM 110 are scaled, rebalanced, and activation values may be shifted into bias values, and so forth.

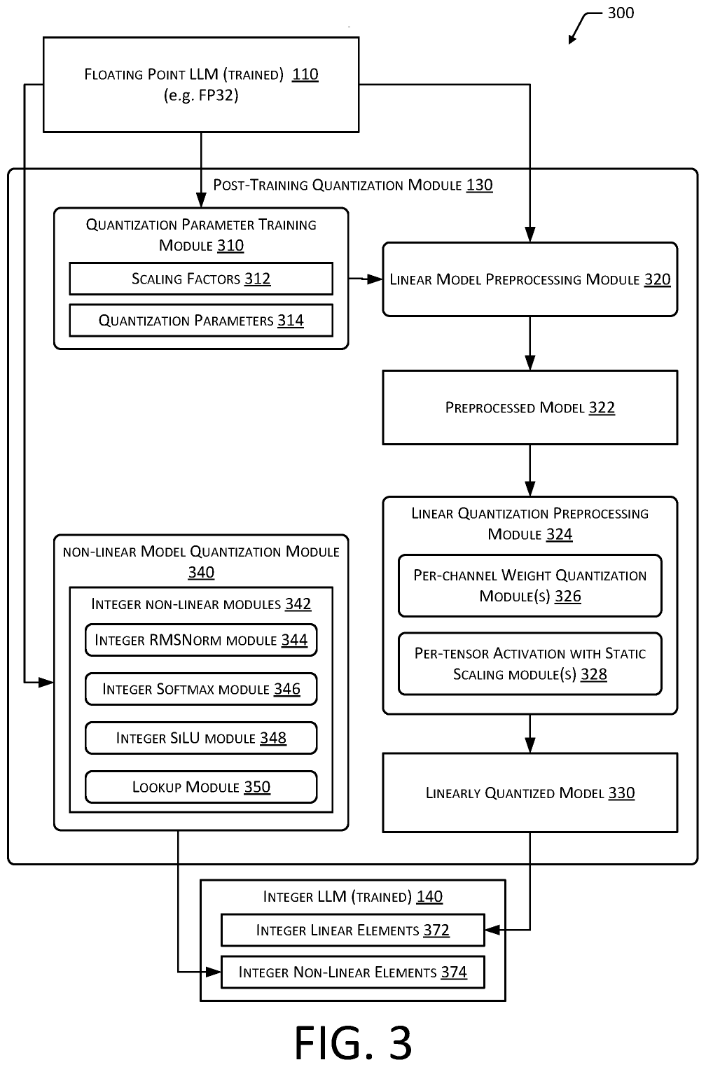

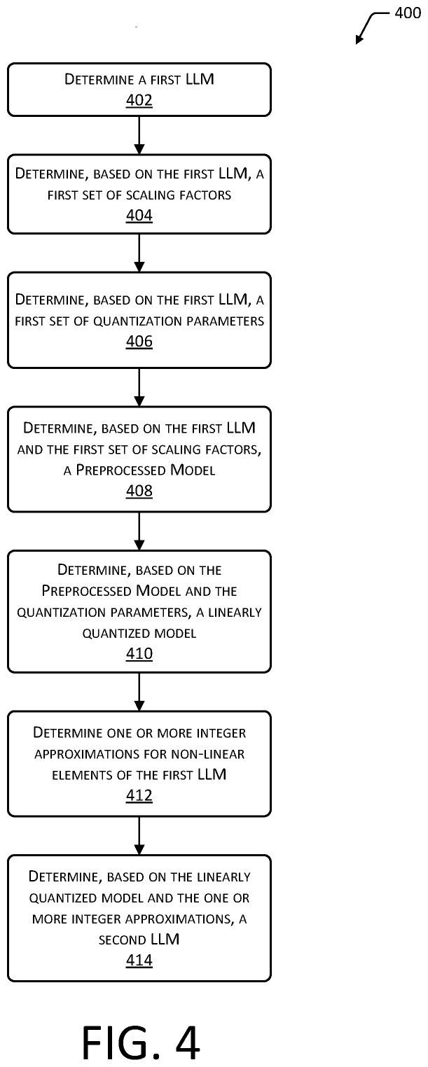

One of the elements of the FP LLM 110 is a linear down projection layer after an activation layer. For example, the down projection layer may process output from a sigmoid-weighted linear unit (SiLU) activation function. Weight-activation scaling may be applied to linear elements, including the down projection layer. This enables per-tensor quantization for activation values 116 to be successfully performed, significantly reducing or eliminating the degradation in accuracy that is traditionally associated with quantization. Per-channel weight quantization may be performed on the weight of linear elements. Non-linear elements are then replaced in the integer LLM 140 with elements that approximate the operation of the non-linear elements using integer values. This process is discussed in more detail with regard to FIGS. 3-4.

The resulting integer LLM 140 represents the weight values 114 and may include static activation scale data that is used to quantize activation values 116 during inference. These may be integers with different bit-depths. For example, weight values 114 may be expressed as integers with a bit-depth of 4 bits, while activation values 116 may be expressed as integers with a bit-depth of 8 bits. As a result of this transition from FP to integers, the overall size of the model is substantially reduced. For example, the size of the FP LLM 110 may be 28 GB while the resulting integer LLM 140 is 3.4 GB. As a result, the integer LLM 140 may be readily stored within the limited memory of an edge device 152.

Compared to the FP LLM 110, the integer LLM 140 may execute more quickly due to processor support for integer operations. For example, on equivalent hardware the integer LLM 140 may produce output twelve times faster than the FP LLM 110. This reduced execution time allows the integer LLM 140 to be executed on edge devices 152 that may have limited processor resources.

In some implementations the integer LLM 140 may be used on other computing devices 162, such as other servers, cloud computing services, and so forth. For example, the reduced memory and processor requirements may be advantageous in situations in which many instantiations of the integer LLM 140 may be executed on the same hardware.

FIG. 2 illustrates at 200 a diagram of one block 112 of an LLM, according to some implementations. As described above, the LLM may comprise a plurality of blocks 112.

An initial block 112 may accept as input an embedding of one or more tokens. Other blocks 112 may accept as input the output from a preceding block 112. The block 112 may include one or more normalization elements, activation elements, and so forth.

In the implementation depicted here, input to the block 112 is processed by a first RMSNorm 202 element. The RMSNorm 202 may implement the root mean square (RMS) layer normalization algorithm, such as promulgated by Zhang and Sennrich. The output from the RMSNorm 202 may provide as output a query (“Q”) 204, key (“K”) 206, and value (“V”) 208 vectors.

A rotary position encoding (RoPE) 210 element accepts as input the Q 204, K 206, and V 208. For example, the ROPE 210 may comprise a rotary position encoding layer. The Q 204 and the K 206 output from the ROPE 210 is provided to a first batched matrix multiplication (BMM) 212 function. Output from the first BMM 212 is provided to a softmax 214 element.

The softmax 214 element may implement the softmax algorithm that provides a smooth approximation to an arg max function. Output from the softmax 214 element and the V 208 are provided to a second BMM 216. Inclusion of one or more of the first BMM 212 or the second BMM 216 substantially improves performance of the resulting integer LLM 140.

Output from the second BMM 216 is provided to a first linear projection 218 element. The output from the first linear projection 218 element and data from the first RMSNorm 202 are summed by a first summation 220 element. Output from the first summation 220 element is provided to a second RMSNorm 250. The second RMSNorm 250 may be part of a gated activation unit. Output from the second RMSNorm 250 is processed by a plurality of linear projection elements, such as a second linear projection element 252 and a third linear projection 254 element. Inclusion of one or more of the second linear projection 252 or the third linear projection 254 may substantially improve performance of the resulting integer LLM 140.

Output from the second linear projection element 252 is provided to a sigmoid-weighted linear unit (SiLU) 256 element. For example, the SiLU 256 may implement the activation algorithm promulgated by Elfwing, Uchibe, and Doya.

A Hadamard product 258 element accepts as input the output from the SiLU 256 and output from the third linear projection 254. The Hadamard product 258 element implements the Hadamard product to calculate a binary product of the inputs. Output from the Hadamard product 258 is provided as input to a linear down projection 260 element. The linear down projection 260 may reduce the dimensionality of the input. The linear down projection 260 element implements a linear down projection algorithm. Inclusion of one or more of the linear down projection 260 elements substantially improves performance of the resulting integer LLM 140.

The output from the linear down projection 260 and the first summation 220 may be provided as input to a second summation 262 element. The second summation 262 element sums the input, and may provide the output to a next block 112 or other layer.

A key 292 indicates the shading used in this illustration to denote if an element is a non-linear layer or a linear layer. Non-linear elements are shaded, while linear elements are not. Non-linear elements may include the first RMSNorm 202, softmax 214, the second RMSNorm 250, and the SiLU 256. The remaining elements may be linear elements.

As mentioned earlier, in the FP LLM 110, the non-linear elements operate on floating point values. As described next with regard to FIG. 3, in the integer LLM 140, the non-linear elements are replaced with linear elements that approximate the operation of the non-linear elements and operate on integer values.

FIG. 3 illustrates at 300 a block diagram of a post-training quantization module 130, according to some implementations. The post-training quantization module 130 may be executed by one or more computing devices 102.

The FP LLM 110 is processed by a quantization parameter training module 310 using the “OmniQuant” algorithm as promulgated by Shao, et. al. The quantization parameter training module 310 determines one or more scaling factors 312 or quantization parameters 314. The scaling factors 312 are indicative of values to be used to scale one or more FP values, such as weight values 114, bias values, or other values. In some implementations the scaling factors 312 may comprise one or more scaling matrices that may be used to balance weight values 114 and activation values 116 such as an activation tensors.

The values, such as weight values 114, may be quantized to integer values. The quantization may use the following parameterized asymmetric minmax quantization formula to determine the quantized weight values 114:

$${W}_{q} = clamp ( ⌊ \frac{W}{h} ⌋ + z , 0 , {2}^{N} - 1 ) ,$$

$$where h = \frac{γ max ( W ) - β min ( W )}{{2}^{N} - 1} , z = - ⌊ \frac{β min ( W )}{h} ⌉$$

where the clipping strengths α and β are from [0, 1] and are determined as part of the quantization parameters 314. The default granularity of weight quantization may be per-channel by default.

### Equation 1

The quantization parameter training module 310 may utilize multiple iterations in a machine learning fashion to determine the quantization parameters 314. A grid search methodology may be used in some implementations. In one implementation, quantization is parameterized by δ, s, γ, β, which are learned by minimizing following output error specified in the following algorithms:

$$arg \begin{matrix}min \\ {⊖}_{1} , {⊖}_{2}\end{matrix} ‖ F ( W , X ) - F ( {Q}_{w} ( W ; {⊖}_{1} , {⊖}_{2} ) , {Q}_{a} ( X , {⊖}_{2} ) ) ‖$$

where F represents one transformer block 112.

### Equation 2

The quantization parameters ⊖₁ and ⊖₂ of Equation 2 are optimized layer by layer using the following algorithm:
1. Evaluate the FP LLM 110 using a specified number of samples from a calibration dataset. Each sample contains a specified number of tokens. For example, 128 samples and 2048 tokens.
2. For each transformer layer in the model, the input X and output F(W, X) are first recorded from the FP LLM 110. There are input output pairs for each layer. For example, 128 pairs in the case of 128 samples.
3. For each layer, the quantized layer is evaluated on the input X. The quantized output F(Q_{w}(W;⊖₁,⊖₂), Qₐ(X,⊖₂)) is compared with the label F(W, X). The parameters ⊖₁ and ⊖₂ are fitted by solving Equation 2.
4. Solve the minimization problem expressed as Equation 2 using the AdamW stochastic optimization method (as promulgated by Loshchilov, et al.) that may be performed over a plurality of epochs. For example, 20 epochs may be performed.

In one implementation, a quantization parameter may be determined based on minimizing a difference between non-quantized output from a layer of the FP LLM 110 and quantized output from that layer.

### Equation 3

With the scaling factors 312 and quantization parameters 314 determined, the FP LLM 110 may be processed. A linear model preprocessing module 320 processes the FP LLM 110 using the scaling factors 312 and the quantization parameters 314 to determine a preprocessed model 322. One or more of the weight values 114, bias values, or the activation values 116 in the preprocessed model 322 may comprise FP values. These values may be scaled relative to the corresponding values in the FP LLM 110. In some implementations, the linear model preprocessing module 320 may scale and shift input activation values 116 of the linear layers by the following learnable equivalent transformation (ET).

$$Y = XW + B = {\underbrace{[ \frac{X - δ}{s} ]}}_{\tilde{x}} \cdot {\underbrace{[ s ⊙ W ]}}_{\tilde{W}} + {[ B + δ W ]}_{\tilde{B}}$$

### Equation 4

Both the shifting and scaling happens per-channel for X. Parameters σ and s are learnable. The ET is a generalization of smooth scaling as proposed in the SmoothQuant (SQ) algorithm. The generalization includes the following aspects: the ET applies per-channel scaling and a shift for the activation values 116. Instead of defining the scaling factor s formulaically as in SmoothQuant, the ET treats it as learnable parameters that are fitted with calibration data.

The ET may be applied to linear modules such as Q/K/V projection 204, 206, 208 and up/gate_proj and o_proj, qk_t and wv. By using the linearity of the linear modules, the scaling factors 312 are folded into the weights of previous layers. The Q/K/V projection layer and up/gate projection layer may be scaled using the following algorithm:

$${XW}^{T} = {XS ( {WS}^{- 1} )}^{T} = RMS ( Y ) {yS ( {WS}^{- 1} )}^{T} = RMS ( Y ) \tilde{y} \tilde{W}$$

where the scaling S can be folded into the weight W and the weight Y of the RMSNorm 202 layer.

### Equation 5

The QK_T layer may be scaled using the following algorithm:

$$R ( Q ) {SS}^{- 1} {R ( K )}^{T} = R ( Q ) {S ( R ( K ) {S}^{- 1} )}^{T}$$

where R(·) represents the ROPE 210, i.e. R(Q)=R_{q}XW_{q}^{T}

### Equation 6

This may be reduced to the following general form. In order to generalize our results in 2D to any xᵢ∈ [symbol] ^{d} where d is even, we divide the d-dimension space into d/2 sub-spaces and combine them in the merit of the linearity of the inner product, turning ∫_{{q,k}} into:

$${\int }_{\{ q , k \}} ( {x}_{m} , m ) = {R}_{⊖ , m}^{d} {W}_{\{ qk \} {x}_{m}}$$

$$where$$

$${ℛ}_{⊖ , m}^{d} = ( \begin{matrix}cos m {θ}_{1} & - sin m {θ}_{1} & 0 & 0 & … & 0 & 0 \\ sin m {θ}_{1} & cos m {θ}_{1} & 0 & 0 & … & 0 & 0 \\ 0 & 0 & cos m {θ}_{2} & - sin m {θ}_{2} & … & 0 & 0 \\ 0 & 0 & sin m {θ}_{2} & cos m {θ}_{2} & … & 0 & 0 \\ ⋮ & ⋮ & ⋮ & ⋮ & ⋱ & ⋮ & ⋮ \\ 0 & 0 & 0 & 0 & … & cos m {θ}_{d / 2} & - sin m {θ}_{d / 2} \\ 0 & 0 & 0 & 0 & … & sin m {θ}_{d / 2} & cos m {θ}_{d / 2}\end{matrix} )$$

$$Then R ( Q ) S = {R}_{q} {XW}_{q}^{T} S = {R}_{q} {X ( S {W}_{q} )}^{T} and R ( K ) {S}^{- 1} = {R}_{k} {X ( {S}^{- 1} {W}_{k} )}^{T} .$$

The scaling between R(Q) and R(K) can be folded into the weight of W_{q,k} separately.

### Equation 7

The Q_Proj layer may be scaled using the following algorithm:

$${X}_{0} S {S}^{- 1} {W}_{0}^{T} = P V S {( {W}_{0} {S}^{- 1} )}^{T} = P ( {X}_{v} {W}_{v}^{T} S ) {( {W}_{0} {S}^{- 1} )}^{T} = P {{X}_{v} ( S {W}_{v} )}^{T} {( {W}_{0} {S}^{- 1} )}^{T}$$

### Equation 8

The O_Proj layer may be scaled using the following algorithm:

$${X}_{0} S {S}^{- 1} {W}_{0}^{T} = P V S {( {W}_{0} {S}^{- 1} )}^{T} = P ( {X}_{v} {W}_{v}^{T} S ) {( {W}_{0} {S}^{- 1} )}^{T} = P {{X}_{v} ( S {W}_{v} )}^{T} {( {W}_{0} {S}^{- 1} )}^{T}$$

in which the scaling factors can be folded into Wᵥ and W₀ separately.

### Equation 9

The linear down projection 260 that is not processed using OmniQuant may be scaled using the following algorithm:

$${X}_{d} S {S}^{- 1} {W}_{d}^{T} = s i l u ( Z ) ⊗ ( {X}_{g} {W}_{g}^{T} ) {S ( {W}_{d} {S}^{- 1} )}^{T} = s i l u ( Z ) ⊗ ( {{X}_{g} ( S {W}_{g} )}^{T} ) {( {W}_{d} {S}^{- 1} )}^{T}$$

in which the scaling factors can be folded into WG and Wa separately.

### Equation 10

In one implementation, the linear model preprocessing module 320 may quantize activation values 116 using an asymmetric minmax quantization without hyperparameters. In some implementations, this may be performed with a per-token granularity.

In one implementation, the linear model preprocessing module 320 may utilize the OmniQuant algorithm as promulgated by Shao, et. al. In other implementations other algorithms may be used, such as the SmoothQuant algorithm promulgated by Xiao, et al. During operation, the linear model preprocessing module 320 may use the OmniQuant algorithm and the scaling factors 312 to rebalance values of tensors in linear elements of the model, such as the BMM 216, linear projection 218, linear projection 252, linear projection 254, linear down projection 260, and so forth. This rebalancing may result in the migration of outlier values from activation values 116 to weight values 114. The resulting preprocessed model 322 comprises weight values 114 that have been scaled or rebalanced, activation values 116 that have been shifted with the shift fused into the bias values, and so forth. In some implementations these values may remain in the original data type of the FP LLM 110, such as FP32.

A linear quantization preprocessing module 324 accepts the preprocessed model 322 as input and provides as output a linearly quantized model 330. The linear quantization preprocessing module 324 may include one or more of per-channel weight quantization module(s) 326 or per-tensor activation with static scaling module(s) 328. The per-channel weight quantization module(s) 326 quantizes weight values 114 channel by channel within a given layer. The per-tensor activation with static scaling module(s) 328 quantizes and scales activation values 116 for an entire tensor that is associated with a given layer. In some implementations, the static scaling may use a scaling factor 312 as determined by the activation calibration.

Different elements of the linearly quantized model 330, now expressed as integers, may utilize different bit depths. For example, the values associated with a first normalization layer such as RMSNorm 202 may be expressed with a first bit depth, such as 4 bits, and values associated with a second normalization layer such as RMSNorm 250 may be expressed with a second bit depth, such as 5 bits.

In some implementations the linearly quantized model 330 may include static scaling data, such as static activation scale data. For example, the static scaling data may be used during inference to determine how activation values 116 are quantized during inference. In other implementations dynamic scaling may be used, with the scaling of activation values 116 determined at inference.

During operation, the linear quantization preprocessing module 324 completes the transition of the linear elements and associated values in the preprocessed model 322 into the quantized values present in the linearly quantized model 330. For example, the FP values are converted to integer values. In some implementations, different bit depths may be used for different values, different layers, and so forth. For example, the bit depth for weight values 114 may be 4 bits and the bit depth for activation values 116 may be 8 bits.

The linearly quantized model 330 provides quantized integer linear elements 372 that may include quantized versions of weight values 114 and activation values 116 associated with non-linear elements of the FP LLM 110. However, the non-linear elements of the model have not yet been modified.

A non-linear model quantization module 340 accepts as input the FP LLM 110 and provides as output integer non-linear elements 374. The non-linear model quantization module 340 may include one or more integer non-linear modules 342 that provide integer approximations of these non-linear functions. These integer non-linear modules 342 may replace the non-linear elements of the FP LLM 110 with equivalents or approximations that utilize integer values as input, operation on those integer values, and provide integer values as output. These equivalents may be provided for non-linear elements such as RMSNorm 202 and 250, Softmax 214, SiLU 256, and so forth.

The integer non-linear modules 342 may include an integer RMSNorm module 344. In one implementation the non-linear RMSNorm algorithm associated with RMSNorm 202 may be defined as:

$$L ( x ) = \frac{x}{\sqrt{\frac{1}{n} {\sum }_{i = 1}^{n} {x}_{i}^{2} + ε}} γ$$

where X represents one token (for example with 4096 features/channels, n=4096) and the weight γ vector of length n_{channel} that is shared by all tokens. So the RMSNorm layer can be viewed as a tokenwise normalization plus a channelwise scaling by γ.

### Equation 11

An integer approximation for this non-linear function may be determined as follows. Suppose X is quantized into (q, S) where q is an integer tensor and S is a scalar scaling factor if we apply per-tensor or per-token quantization for X. The RMSNorm layer can be evaluated by using integer arithmetic by using the following algorithm:

$$L ( q , S ) = ⌊ \sqrt{n} ⌋ q ⌊ \frac{1}{i S qrt ( {\sum }_{i = 1}^{n} {q}_{i}^{2} + ⌊ n ε / {S}^{2} ⌋ )} ⌋ γ$$

where iSqrt is an exact approximation └\sqrt{n}┘ for any positive integer n.

### Equation 12

The iSqrt may comprise the integer-only square root approximation promulgated by Kim, et al.

Two shifts may be applied to the output to avoid overflow and underflow (round to zero) situations. To avoid overflow when evaluating the sum of squares Σᵢ₌₁ⁿqᵢ², the tensor q is scaled by 2⁻¹. To avoid rounding to zero, the ratio 1/iSqrt( ) is first shifted by 2^{r} and then rounded to integer. The exponent r is set to be maximum possible digits 32, resulting in the following algorithm:

$$L ( q , S ) = ( ⌊ \sqrt{n} ⌋ {2}^{- ( r - 2 )} γ ) q ⌊ \frac{{2}^{r - 2}}{2 / iSqrt ( {\sum }_{i = 1}^{n} {( 2 \text{-/} {q}_{i} )}^{2} + ⌊ n ε / {S}^{2} ⌋ )} ⌋$$

### Equation 13

To determine the shift parameter l and r, the integer RMSNorm may be tested using sample test tensors offloaded when evaluating the FP LLM 110 on selected data. The ranges of Σᵢ₋₁ⁿ(2⁻¹qᵢ)² and

$$\frac{{2}^{r - 2}}{\sqrt{\sum }}$$

may be stored. The error for the ratio x/rms(x) may also be stored. In addition to the shift to each summand by 2⁻¹, we can also consider shifting the summation by 2^{-s} and then shift the sqrt by 2^{-s/2}. For example, consider:

$$i Sqrt ( \sum ) \approx {2}^{s / 2} i S qrt ( ⌊ {2}^{- s} \sum ⌋ )$$

where r is the maximum allowed value and incrementally increases | from 0 to 2.

### Equation 14

In general, consider casting a number a into integer. The first type of shifting is applied when the magnitude of a exceeds the range of the target precision. It commits the following error:

$$\vert {2}^{/} ⌊ α / {2}^{/} ⌋ - α \vert = {2}^{/} \vert ⌊ α / {2}^{/} ⌋ - α / {2}^{/} \vert \leq {2}^{/}$$

### Error 1

If α<2^{/}, the error equals |α|, otherwise, it is of order 2^{/} on average. So in practice, the shift amount | should be the smallest one that brings α into the target range, i.e. l=[log₂ α−m], where m is the largest allowable number of digits (code). In order to make | as small as possible, we can either increase m or reduce α.

The second type of shifting is applied when rounding 1/α into integers. To avoid rounding to zero when 1/α<1, 1/α is shift to 2^{r}/α>1 and then apply the rounding. This kind of shifting commits the following error:

$$\vert {2}^{- r} ⌊ {2}^{r} / α ⌋ - 1 / α \vert = {2}^{- r} \vert ⌊ {2}^{r} / α ⌋ - {2}^{r} / α \vert \leq {2}^{- r}$$

### Error 2

To minimize the error during operation, r may be set as large as possible. For example, r=31 in an implementation associated with int32.

Example code of the integer version of RMSNorm in the Python language is included in the attached Computer Program Listing Appendix.

The integer non-linear modules 342 may include an integer Softmax module 346. Approximation in the continuous domain associated with the SoftMax function may be approximated in the following equations:

$${f}_{i} ( x ) = \frac{exp ( {x}_{i} )}{{\sum }_{j} exp ( {x}_{j} )}$$

or alternatively

$${f}_{i} ( x ) = \frac{exp ( {\tilde{x}}_{i} )}{{\sum }_{j} exp ( {\tilde{x}}_{j} )} ,$$

$${\tilde{x}}_{j} = {x}_{j} - \begin{matrix}max \\ k\end{matrix} {x}_{k} \leq 0$$

### Equation 15

Suppose \tilde{x}ⱼ=(−In2)zⱼ+rⱼ, where rⱼϵ(−In2, 09 , then

$${f}_{i} ( x ) = \frac{{2}^{- {Z}_{i}} exp ( {r}_{i} )}{{\sum }_{j} {2}^{- {Z}_{j}} exp ( {r}_{j} )} ,$$

$${Z}_{j} > 0 , {r}_{j} ϵ ( - In 2 , 0 )$$

### Equation 16

The I-BERT approximation as promulgated by Kim seeks a quadratic approximation p(r)≈exp(r) for rϵ(−In2, 0). The following polynomial based approximation for softmax may be as follows:

$$\tilde{{f}_{ι}} ( x ) = \frac{{2}^{- {Z}_{i}} p ( {r}_{i} )}{{\sum }_{j} {2}^{- {Z}_{j}} p ( {r}_{j} )} ,$$

$${Z}_{j} > 0 , {r}_{j} ϵ ( - In 2 , 0 )$$

### Equation 17

In floating-point numerics, due to the round-off error and the monotonic property of exp(x), for x<0, the domain can be truncated to xϵ[−β, 0], where exp(−β)=ϵ at the level of machine zero of the working precision. For example, for fp16, given β=10, and in this case zϵ[0, 14.42). In the formula above, Zᵢ may be replaced with Zᵢ=min {Zᵢ, 14.42}.

The integer approximation may be used as is defined in “Integer-only Exponential and Softmax” (“i_exp”) as specified by Kim as discussed with regard to I-BERT. Suppose the input vector x is quantized into (q,S) where q is a vector of integers and S is the scaling factor such that

$${‖ qS - x ‖}_{∞} \leq \frac{S}{2} .$$

To mimic the approximation in the continuous domain, q is first normalized by subtracting the maximum value.

$${\tilde{q}}_{j} = {q}_{j} - {q}_{max}$$

### Equation 18

The shift Zⱼ and rⱼ is then derived as follows. Note that \tilde{q}ⱼ/(−In2/S)=zⱼ+rⱼ/(−In2) and rⱼ/(−In2)ϵ(0, 1) then the following is defined:

$${Z}_{j} = ⌊ {\tilde{q}}_{j} / {S}_{In 2} ⌋ ,$$

$${S}_{In 2} = ⌊ ( - In 2 ) / S ⌋$$

$$and$$

$${\tilde{r}}_{j} = {\tilde{q}}_{j} - {Z}_{j} {S}_{In 2}$$

### Equation 19

Then input (\tilde{r}ⱼ, S) into the integer evaluation and obtain (pⱼ, Sₚ), with Sₚpⱼ≈exp(\tilde{r}ⱼS). Then to obtain approximation for exp(\tilde{q}ⱼ), further shift by Zⱼ bits and get (pⱼ2^{-z}^{^{j}}, Sₚ). The approximation for the \tilde{f}ᵢ(x) is:

$$\tilde{{f}_{i}} ( x ) \approx \frac{{p}_{i} {2}^{- {Z}_{i}}}{{\sum }_{j = 1}^{n} {p}_{j} {2}^{- {Z}_{j}}}$$

### Equation 20

When performing this step, two shiftings are applied to avoid underflow and overflow. pⱼ2^{-Z}^{ⱼ} could be possibly 0. So to avoid this shift t−zⱼ instead of −zⱼ for each term. However, t can not be too large. Otherwise, the summation will overflow.

Note that rⱼ here is actually scaled by S, i.e.

$${r}_{j} \approx ⌊ \frac{{r}_{j}}{s} ⌋$$

and S is the scaling factor for x, which is usually large compared to the scale of rϵ(−In2, 0). This will result in the “not a number” (NAN) in practice. Consider quantizing a input tensor into int8 with max x>128. Then S>1 and hence the input for the polynomial [rⱼ/S]=0. Moreover, when S>1.7, the constant term of the polynomial c=[3.5/S²]=0. Therefore, when S>1.7, the output of I-Poly is zero for any q and hence qe/sum(qe) is NAN. One way to fix this is to increase n such that S=|X|ₘₐₓ/2ⁿ⁻¹<1 to avoid NAN. Another way is to re-quantize \tilde{X}. Observe that after the shift \tilde{X}ⱼ=max{X−Xₘₐₓ, −β}, the scaling factor is \tilde{S}=maxⱼ|\tilde{x}ⱼ|/2ⁿ⁻¹≤β/2ⁿ⁻¹<1. In this case:

$${\tilde{q}}_{j} \tilde{S} = max \{ ( {q}_{j} - {q}_{max} ) S , - β \}$$

### Equation 21

The shifted input can be re-quantized as:

$${\tilde{q}}_{j} = max \{ ( {q}_{j} - {q}_{max} ) ⌊ S / \tilde{S} ⌋ , - ⌊ β / \tilde{S} ⌋ \}$$

### Equation 22

The integer non-linear modules 342 may include an integer SiLU module 348 that approximates a non-linear SiLU activation function. The SiLU activation function, such as used in a multilayer perception (MLP) may be described as follows:

SiLU(x)=xσ(x)
where σ(x)=1/(1+exp(−x)) is the sigmoid function.

To determine an integer approximation, the SiLU function may be rewritten into the following form:

$$S i L U ( x ) = \frac{x}{2} [ 1 + \frac{1 - exp ( - x )}{1 + exp ( - x )} ] = \frac{x}{2} [ 1 + sgn ( x ) \frac{1 - exp ( - \vert x \vert )}{1 + exp ( - \vert x \vert )} ]$$

### Equation 23

In this form, e^{x} is quantized in the negative domain (−∞, 0]. This can be done by using an i_exp subroutine, such as described with regard to the iSoftmax approximation in the integer softmax module 346. In numerical evaluation, due to the round-off error, the negative domain can be truncated in some implementations into (−10, 0], since e⁻¹⁰=4.5×10⁻⁵ is already below the level of machine zero of bfloat16.

The polynomial approximation may be further quantized as:

$$\frac{x}{2} [ 1 + sgn ( x ) \frac{1 - i\_exp ( - \vert x \vert )}{1 + i\_exp ( - \vert x \vert )} ]$$

Suppose the i_exp produces (qₑ, Sₑ) for input (qₓ, Sₓ), then

$$\begin{matrix}S ( {q}_{x} {S}_{x} ) = \frac{{q}_{x} {S}_{x}}{2} ( 1 + sgn ( x ) \frac{1 - {q}_{e} {S}_{e}}{1 + {q}_{e} {S}_{e}} ) \\ = \frac{{q}_{x} {S}_{x}}{2} \frac{( 1 + sgn ( x ) ) + ( 1 - sgn ( x ) ) ( {q}_{e} {S}_{e} )}{1 + {q}_{e} {S}_{e}} \\ = \frac{{q}_{x} {S}_{x}}{2} \frac{\frac{1 + sgn ( x )}{{S}_{e}} + ( 1 - sgn ( x ) ) {q}_{e}}{\frac{1}{{S}_{e}} + {q}_{e}}\end{matrix}$$

where sgn(x) is a function that returns a sign of a real number.

### Equation Set 1

It is possible to precompute

$$⌊ \frac{1 + sgn ( x )}{{S}_{e}} ⌋ and ⌊ \frac{1}{{S}_{e}} ⌋$$

and evaluate the integer ratio. This ratio is bounded by 2 and thus can be rescaled by 2/2\hat{ }m to avoid rounding to zero, where m is the output digit. Then the final output is:

$${q}_{s} = {q}_{x} ⌊ {2}^{m - 1} \frac{( 1 + sgn ( x ) ) ⌊ \frac{1}{{S}_{e}} ⌋ + ( 1 - sgn ( x ) ) {q}_{e}}{⌊ \frac{1}{{S}_{e}} ⌋ + {q}_{e}} ⌋ , {S}_{s} = {S}_{x} / {2}^{m}$$

where qₓ is a quantized input, Sₓ is a scaling factor associated with the quantized input, and (qₑ, Sₑ) are determined based on processing inputs with the i_exp algorithm, m is an output digit, and sgn(x) returns a sign of a real number.

### Equation 24

Example code of the integer version of the SiLU module in the Python language is included in the attached Computer Program Listing Appendix.

The integer non-linear modules 342 may include a lookup module 350. In some implementations a non-linear element may be approximated using a lookup table of previously determined values. For example, the lookup table may be used to determine, given a particular input, a particular output.

The integer LLM 140 comprises the integer linear elements 372 and the integer non-linear elements 374.

FIG. 4 is a flow diagram 400 of a process to perform post-training quantization, according to some implementations. The process may be executed by one or more computing devices 102.

At 402 a first LLM is determined. For example, the FP LLM 110 may be trained and stored in memory. The first LLM may comprise a first set of floating point values.

At 404, based on the first LLM, a first set of scaling factors 312 are determined. For example, the quantization parameter training module 310 may be used to determine one or more scaling factors 312.

At 406, based on the first LLM, a first set of quantization parameters 314 are determined. For example, the quantization parameter training module 310 may be used to determine one or more quantization parameters 314.

At 408, based on the first LLM and the first set of scaling factors, a preprocessed model 322 is determined. For example, the linear model preprocessing module 320 may process the FP LLM 110 to determine the preprocessed model 322. The preprocessed model 322 may comprise a second set of floating point values that are scaled relative to corresponding values of the first set of floating point values.

At 410 a linearly quantized model 330 is determined based on the preprocessed model 322 and the quantization parameters 314. The linearly quantized model 330 may comprise integer quantized values based on one or more of the second set of floating point values. One or more linear elements of the preprocessed model 322 may be replaced with integer equivalents. In one implementation, FP versions of linear elements such as ROPE 210, BMM 212, and so forth may be replaced with integer versions that operate on integer values. For example, the linear quantization preprocessing module 324 may process the preprocessed model 322 to determine the linearly quantized model 330.

At 412 one or more integer approximations for non-linear elements of the first LLM 110 are determined. In one implementation, the one of more of the integer non-linear modules 342 may be retrieved. For example, the integer RMSNorm module 344, integer softmax module 346, integer SiLU module 348, and so forth may be retrieved.

At 414, based on the linearly quantized model 330 and the one or more integer approximations, a second LLM is determined. For example, the quantized weight values 114 and activation values 116 or static scaling data representative of activation values 116 at inference are combined with linear elements of the linearly quantized model 330 and the integer non-linear modules 342 to provide the integer LLM 140. The non-linear elements of the linearly quantized model 330 may be replaced with linear versions. For example, the FP RMSNorm 202 may be replaced with the integer RMSNorm module 344, the FP Softmax 214 may be replaced with the integer softmax module 346, the FP SiLU 256 may be replaced with the integer SiLU module 348, and so forth.

The resulting second LLM is an integer LLM 140 that represents the weight values 114 and one or more of activation values 116 or static scaling data representative of activation values 116 at inference using integers. These may be integers with different bit-depths. For example, weight values 114 may be expressed as integers with a bit-depth of 4 bits, while activation values 116 at inference may be expressed as integers with a bit-depth of 8 bits. Compared to the FP LLM 110, the overall size of the integer LLM 140 is substantially reduced.

Compared to the FP LLM 110, the integer LLM 140 may execute more quickly due to processor support for integer operations. This allows the integer LLM 140 to be executed on edge devices 152 that may have limited processor resources.

FIG. 5 is a block diagram 500 of a computing device 102 to implement the system 100, according to some implementations. The computing device 102 may be implemented as one or more of an “embedded system”, “on-demand computing”, “software as a service (Saas)”, “platform computing”, “network-accessible platform”, “cloud services”, “data centers”, and so forth. Services provided by the computing device 102 may be distributed across one or more physical or virtual devices.

One or more power supplies 502 may be configured to provide electrical power suitable for operating the components in the computing device 102. The one or more power supplies 502 may comprise batteries, connections to an electric utility, and so forth. The computing device 102 may include one or more hardware processors 504 (processors) configured to execute one or more stored instructions. For example, the hardware processors 504 may include application specific integrated circuits (ASICs), field-programmable gate arrays (FPGAs), digital signal processors (DSPs), hardware accelerators, graphics processing units (GPUs), and so forth. The processors 504 may comprise one or more cores. One or more clocks 506 may provide information indicative of date, time, ticks, and so forth.

The computing device 102 may include one or more communication interfaces 508 such as input/output (I/O) interfaces 510, network interfaces 512, and so forth. The communication interfaces 508 enable the computing device 102, or components thereof, to communicate with other devices or components. The communication interfaces 508 may include one or more I/O interfaces 510. The I/O interfaces 510 may comprise Inter-Integrated Circuit (I2C), Serial Peripheral Interface bus (SPI), Universal Serial Bus (USB) as promulgated by the USB Implementers Forum, RS-232, Peripheral Component Interconnect (PCI), serial AT attachment (SATA), and so forth.

The I/O interface(s) 510 may couple to one or more I/O devices 514. The I/O devices 514 may include input devices 516 such as one or more of a sensor, keyboard, mouse, scanner, and so forth. The I/O devices 514 may also include output devices 518 such as one or more of a display device, printer, audio speakers, and so forth. In some embodiments, the I/O devices 514 may be physically incorporated with the computing device 102 or may be externally placed.

The network interfaces 512 may be configured to provide communications between the computing device 102 and other devices, such as routers, access points, and so forth. The network interfaces 512 may include devices configured to couple to personal area networks (PANs), local area networks (LANs), wireless local area networks (WLANS), wide area networks (WANs), and so forth. For example, the network interfaces 512 may include devices compatible with Ethernet, Wi-Fi, Bluetooth, and so forth.

The computing device 102 may also include one or more buses or other internal communications hardware or software that allow for the transfer of data between the various modules and components of the computing device 102.

As shown in FIG. 5, the computing device 102 includes one or more memories 520. The memory 520 may comprise one or more non-transitory computer-readable storage media (CRSM). The CRSM may be any one or more of an electronic storage medium, a magnetic storage medium, an optical storage medium, a quantum storage medium, a mechanical computer storage medium, and so forth. The memory 520 provides storage of computer-readable instructions, data structures, program modules, and other data for the operation of the computing device 102. A few example functional modules are shown stored in the memory 520, although the same functionality may alternatively be implemented in hardware, firmware, or as a system on a chip (SoC).

The memory 520 may include at least one operating system (OS) module 522. The OS module 522 is configured to manage hardware resource devices such as the I/O interfaces 510, the I/O devices 514, the communication interfaces 508, and provide various services to applications or modules executing on the processors 504. The OS module 522 may implement a variant of the FreeBSD operating system as promulgated by the FreeBSD Project; other UNIX or UNIX-like variants; a variation of the Linux operating system as promulgated by Linus Torvalds; the Windows operating system from Microsoft Corporation of Redmond, Washington, USA; and so forth.

Also stored in the memory 520 may be a data store 524 and one or more of the following modules. For example, these modules may be executed as foreground applications, background tasks, daemons, and so forth. The data store 524 may use a flat file, database, linked list, tree, executable code, script, or other data structure to store information. In some implementations, the data store 524 or a portion of the data store 524 may be distributed across one or more other devices including other computing devices 102, network attached storage devices, and so forth.

The data store 524 may store one or more of the FP LLM 110, scaling factors 312, quantization parameters 314, the preprocessed model 322, the linearly quantized model 330, the integer LLM 140, and so forth.

A communication module 526 may be configured to establish communications with other computing devices 102 or other devices. The communications may be authenticated, encrypted, and so forth.

The memory 520 may also store the post-training quantization module 130.

Other modules 540 may also be present in the memory 520 as well as other data 542 in the data store 524. For example, an administrative module may provide a web interface to allow operators to modify operation of the post-training quantization module 130 and so forth.

The processes discussed herein may be implemented in hardware, software, or a combination thereof. In the context of software, the described operations represent computer-executable instructions stored on one or more non-transitory computer-readable storage media that, when executed by one or more processors, perform the recited operations. Generally, computer-executable instructions include routines, programs, objects, components, data structures, and the like that perform particular functions or implement particular abstract data types. Those having ordinary skill in the art will readily recognize that certain steps or operations illustrated in the figures above may be eliminated, combined, or performed in an alternate order. Any steps or operations may be performed serially or in parallel. Furthermore, the order in which the operations are described is not intended to be construed as a limitation.

Embodiments may be provided as a software program or computer program product including a non-transitory computer-readable storage medium having stored thereon instructions (in compressed or uncompressed form) that may be used to program a computer (or other electronic device) to perform processes or methods described herein. The computer-readable storage medium may be one or more of an electronic storage medium, a magnetic storage medium, an optical storage medium, a quantum storage medium, and so forth. For example, the computer-readable storage media may include, but is not limited to, hard drives, optical disks, read-only memories (ROMs), random access memories (RAMs), erasable programmable ROMs (EPROMs), electrically erasable programmable ROMs (EEPROMs), flash memory, magnetic or optical cards, solid-state memory devices, or other types of physical media suitable for storing electronic instructions. Further, embodiments may also be provided as a computer program product including a transitory machine-readable signal (in compressed or uncompressed form). Examples of transitory machine-readable signals, whether modulated using a carrier or unmodulated, include, but are not limited to, signals that a computer system or machine hosting or running a computer program can be configured to access, including signals transferred by one or more networks. For example, the transitory machine-readable signal may comprise transmission of software by the Internet.

Separate instances of these programs can be executed on or distributed across any number of separate computer systems. Thus, although certain steps have been described as being performed by certain devices, software programs, processes, or entities, this need not be the case, and a variety of alternative implementations will be understood by those having ordinary skill in the art.

Additionally, those having ordinary skill in the art will readily recognize that the techniques described above can be utilized in a variety of devices, environments, and situations. Although the subject matter has been described in language specific to structural features or methodological acts, it is to be understood that the subject matter defined in the appended claims is not necessarily limited to the specific features or acts described. Rather, the specific features and acts are disclosed as illustrative forms of implementing the claims.

What is claimed is:

1. A system comprising:
a memory, storing first computer-executable instructions; and
a hardware processor to execute the first computer-executable instructions to:
determine a first large language model (LLM), wherein the first LLM comprises a first set of floating point values;
determine, based on the first LLM, a first set of scaling factors;
determine, based on the first LLM, a first set of quantization parameters;
determine, based on the first LLM and the first set of scaling factors, a preprocessed model, wherein a second set of floating point values of the preprocessed model are scaled relative to corresponding values of the first set of floating point values;
determine, based on the preprocessed model and the first set of quantization parameters, a linearly quantized model, wherein the linearly quantized model comprises integer quantized values based on one or more of the second set of floating point values;
determine one or more integer approximations for non-linear elements of the first LLM; and
determine, based on the linearly quantized model and the one or more integer approximations, a second LLM, wherein the second LLM comprises a first set of integer values and the one or more integer approximations replace corresponding non-linear elements of the first LLM.

2. The system of claim 1, the hardware processor to execute the first computer-executable instructions to:
determine a first quantization parameter of the first set of quantization parameters based on minimizing a difference between non-quantized output and quantized output from a first layer of the first LLM.

3. The system of claim 1, the hardware processor to execute the first computer-executable instructions to:
determine a first set of values within a first normalization layer of the second LLM, wherein the first set of values are expressed using a first bit depth; and
determine a second set of values within a second normalization layer of the second LLM, wherein the second set of values are expressed using a second bit depth that is different from the first bit depth.

4. The system of claim 1, the hardware processor to execute the first computer-executable instructions to:
determine, based on input to a normalization layer of the first LLM:
a first set of vector values,
a second set of vector values, and
a third set of vector values;
determine a fourth set of vector values and a fifth set of vector values using the first set of vector values and the second set of vector values as input to a rotary position encoding layer of the first LLM;
determine first data using the fourth set of vector values and the fifth set of vector values as inputs to a first batched matrix multiplication function of the first LLM;
determine second data using the first data as input to an activation layer;
determine third data using the second data and the third set of vector values as input to a second batched matrix multiplication function of the first LLM; and
determine fourth data using the third data as input to a linear down projection layer of the first LLM.

5. The system of claim 1, the hardware processor to execute the first computer-executable instructions to:
determine a first set of values using a first activation layer of the first LLM; and
determine a second set of values using the first set of values as input to a linear down projection layer of the first LLM.

6. The system of claim 1, the hardware processor to execute the first computer-executable instructions to:
determine the linearly quantized model based on a per-tensor activation quantization using static scaling of the preprocessed model.

7. The system of claim 1, the hardware processor to execute the first computer-executable instructions to:
determine the linearly quantized model based on a per-channel weight quantization of the preprocessed model.

8. The system of claim 1, the hardware processor to execute the first computer-executable instructions to:
determine an integer approximation for a sigmoid-weighted linear unit (SiLU) in the first LLM, wherein the integer approximation for the SiLU utilizes the equation:
$${q}_{s} = {q}_{x} ⌊ {2}^{m - 1} \frac{( 1 + sgn ( x ) ) ⌊ \frac{1}{{S}_{e}} ⌋ + ( 1 - sgn ( x ) ) {q}_{e}}{⌊ \frac{1}{{S}_{e}} ⌋ + {q}_{e}} ⌋ , {S}_{s} = \frac{{S}_{x}}{{2}^{m}}$$
where qₓ is a quantized input, Sₓ is a scaling factor associated with the quantized input, and (qₑ, Sₑ) are determined based on processing inputs with an i_exp algorithm, m is an output digit, and sgn(x) returns a sign of a real number.

9. A computer-implemented method comprising:
determining a first large language model (LLM), wherein the first LLM comprises a first set of floating point values;
determining, based on the first LLM, a first set of scaling factors;
determining, based on the first LLM, a first set of quantization parameters;
determining, based on the first LLM and the first set of scaling factors, a preprocessed model, wherein a second set of floating point values of the preprocessed model are scaled relative to corresponding values of the first set of floating point values;
determining, based on the preprocessed model and the first set of quantization parameters, a linearly quantized model, wherein the linearly quantized model comprises integer quantized values based on one or more of the second set of floating point values;
determining one or more integer approximations for non-linear elements of the first LLM; and
determining, based on the linearly quantized model and the one or more integer approximations, a second LLM, wherein the second LLM comprises a first set of integer values and the one or more integer approximations replace corresponding non-linear elements of the first LLM.

10. The method of claim 9, further comprising:
determining a first quantization parameter of the first set of quantization parameters based on minimizing a difference between non-quantized output and quantized output from a first layer of the first LLM.

11. The method of claim 9, further comprising:
determining a first set of values within a first normalization layer of the second LLM, wherein the first set of values are expressed using a first bit depth; and determining a second set of values within a second normalization layer of the second LLM, wherein the second set of values are expressed using a second bit depth that is different from the first bit depth.

12. The method of claim 9, further comprising:
determining, based on input to a normalization layer of the first LLM:
a first set of vector values,
a second set of vector values, and
a third set of vector values;
determining a fourth set of vector values and a fifth set of vector values using the first set of vector values and the second set of vector values as input to a rotary position encoding layer of the first LLM;
determining first data using the fourth set of vector values and the fifth set of vector values as inputs to a first batched matrix multiplication function of the first LLM;
determining second data using the first data as input to an activation layer;
determining third data using the second data and the third set of vector values as input to a second batched matrix multiplication function of the first LLM; and
determining fourth data using the third data as input to a linear down projection layer of the first LLM.

13. The method of claim 9, further comprising:
determining a first set of values using a first activation layer of the first LLM;
determining a second set of values using the first set of values as input to a linear down projection layer of the first LLM; and
determining the linearly quantized model based on a per-tensor activation quantization using static scaling of the preprocessed model.

14. The method of claim 9, further comprising:
determining an integer approximation for a sigmoid-weighted linear unit (SiLU) in the first LLM, wherein the integer approximation for the SiLU utilizes the equation:
$${q}_{s} = {q}_{x} ⌊ {2}^{m - 1} \frac{( 1 + sgn ( x ) ) ⌊ \frac{1}{{S}_{e}} ⌋ + ( 1 - sgn ( x ) ) {q}_{e}}{⌊ \frac{1}{{S}_{e}} ⌋ + {q}_{e}} ⌋ , {S}_{s} = \frac{{S}_{x}}{{2}^{m}}$$
where qₓ is a quantized input, Sₓ is a scaling factor associated with the quantized input, and (qₑ, Sₑ) are determined based on processing inputs with an i_exp algorithm, m is an output digit, and sgn(x) returns a sign of a real number.

15. A system comprising:
a memory, storing first computer-executable instructions; and
a hardware processor to execute the first computer-executable instructions to:
determine a first set of values using a first activation layer of a first large language model (LLM); and
determine a second set of values using the first set of values as input to a linear down projection layer of the first LLM, wherein the first LLM comprises a first set of floating point values;
determine, based on the first LLM, a first set of scaling factors;
determine, based on the first LLM, a first set of quantization parameters;
determine, based on the first LLM and the first set of scaling factors, a preprocessed model, wherein a second set of floating point values of the preprocessed model are scaled relative to corresponding values of the first set of floating point values;
determine, based on the preprocessed model and the first set of quantization parameters, a linearly quantized model, wherein the linearly quantized model comprises integer quantized values based on one or more of the second set of floating point values;
determine one or more integer approximations for non-linear elements of the first LLM; and
determine, based on the linearly quantized model and the one or more integer approximations, a second LLM, wherein the second LLM comprises a first set of integer values and the one or more integer approximations replace corresponding non-linear elements.

16. The system of claim 15, the hardware processor to execute the first computer-executable instructions to:
determine a first quantization parameter of the first set of quantization parameters based on minimizing a difference between non-quantized output and quantized output from a first layer of the first LLM.

17. The system of claim 15, the hardware processor to execute the first computer-executable instructions to:
determine a third set of values within a first normalization layer of the second LLM, wherein the third set of values are expressed using a first bit depth; and
determine a fourth set of values within a second normalization layer of the second LLM, wherein the fourth set of values are expressed using a second bit depth that is different from the first bit depth.

18. The system of claim 15, the hardware processor to execute the first computer-executable instructions to:
determine, based on input to a normalization layer of the first LLM:
a first set of vector values,
a second set of vector values, and
a third set of vector values;
determine a fourth set of vector values and a fifth set of vector values using the first set of vector values and the second set of vector values as input to a rotary position encoding layer of the first LLM;
determine first data using the fourth set of vector values and the fifth set of vector values as inputs to a first batched matrix multiplication function of the first LLM;
determine second data using the first data as input to an activation layer;
determine third data using the second data and the third set of vector values as input to a second batched matrix multiplication function of the first LLM; and
determine fourth data using the third data as input to a linear down projection layer of the first LLM.

19. The system of claim 15, the hardware processor to execute the first computer-executable instructions to:
determine the linearly quantized model based on:
a per-tensor activation quantization using static scaling of the preprocessed model, and
a per-channel weight quantization of the preprocessed model.

20. The system of claim 15, the hardware processor to execute the first computer-executable instructions to:
determine an integer approximation for a sigmoid-weighted linear unit (SiLU) in the first LLM, wherein the integer approximation for the SiLU utilizes the equation:
$${q}_{s} = {q}_{x} ⌊ {2}^{m - 1} \frac{( 1 + sgn ( x ) ) ⌊ \frac{1}{{S}_{e}} ⌋ + ( 1 - sgn ( x ) ) {q}_{e}}{⌊ \frac{1}{{S}_{e}} ⌋ + {q}_{e}} ⌋ , {S}_{s} = \frac{{S}_{x}}{{2}^{m}}$$
where qₓ is a quantized input, Sₓ is a scaling factor associated with the quantized input, and (qₑ, Sₑ) are determined based on processing inputs with an i_exp algorithm, m is an output digit, and sgn(x) returns a sign of a real number.
